(19) United States
(12) Patent Application Publication
(10) Pub. No.: US 2026/0220990 A1
(43) Pub. Date: Jul. 30, 2026

(54) ANTI-THEFT LOCK

(71) Applicant: SHENYANG SUPDON TECHNOLOGY CO., LTD., Shenyang City (CN)

(72) Inventors: XIN QI, Shenyang City (CN); ZHENBO WANG, Shenyang City, Liaoning Province (CN)

(73) Assignee: SHENYANG SUPDON TECHNOLOGY CO., LTD., Shenyang City (CN)

(21) Appl. No.: 19/574,423

(22) Filed: Mar. 22, 2026

Related U.S. Application Data
(63) Continuation of application No. PCT/CN2023/139684, filed on Dec. 19, 2023.

(30) Foreign Application Priority Data
Aug. 29, 2023 (CN) 202311094799.0

(51) Int. Cl. G07C 9/00

(52) U.S. Cl. CPC G07C 9/00563; G07C 2209/08

(57) ABSTRACT

Disclosed is an anti-theft lock, which includes an anti-theft mechanical combination lock, a lock control mechanism, and a biological recognition device, wherein the biological recognition device controls, by means of controlling the lock control mechanism, whether the anti-theft mechanical combination lock can be unlocked by means of a correct password. After verification of a biological key is passed, the lock control mechanism releases the control of an unlocking hook of the anti-theft mechanical combination lock within a preset time, such that the anti-theft mechanical combination lock can be unlocked by means of a correct password. When biological recognition verification is not passed, the lock control mechanism makes the unlocking hook of the anti-theft mechanical combination lock be out of contact with a driving wheel, such that the anti-theft mechanical combination lock is in a failed state in which the code-embodiment mechanical anti-theft lock cannot be unlocked.

### CROSS-REFERENCE

This application is a continuation of International Application No. PCT/CN2023/139684 with a filling date of December 19, 2023, designating the United States, now pending, which further claims to the benefit of priority from Chinese Application No. 202311094799.0 with a filing date of August 29, 2023. The content of the aforementioned applications, including any intervening amendments thereto, are incorporated herein by reference.

### TECHNICAL FIELD

The present disclosure relates to the technical field of anti-theft lock, in particular to an anti-theft lock.

### BACKGROUND

For a long time, anti-theft mechanical combination locks have been widely used in high security door control fields such as bank vaults, arsenals, and safes. Due to their pure mechanical structure and the need for manual combination lock opening, their reliability and security are relatively high. But there is a problem that it can not recognize the person, when the password (combination code) is leaked, and anyone can unlock the lock. In addition, when sufficient time is available, a thief can still decipher the password and open the lock through continuous trial and error or by exploiting the clicking sounds emitted when the tip of the locking hook passes the contact points at both ends of the notch of driving wheel.

In recent years, biometric locks based on biometric features such as fingerprints, palm prints, and faces have been widely used. These locks consist of biometric devices and electronic locks, which have the advantage of accurate identification of individuals. However, there is the issue of biometric locks being bypassed using cloned or spoofed credentials through technical means, such as using silicone fingerprints to decipher optical fingerprint sensors, using 3D printed face models to decipher facial recognition.

In order to improve security, the existing technology adopts a scheme of using anti-theft mechanical combination locks and biometric locks to jointly control the warehouse door, it forms a dual authentication system that requires both code recognition and person recognition, the security has been improved. However, this is only a simple combination of the two kinds of locks, not achieving a synergistic effect. There is still a problem that anti-theft mechanical combination locks and biometric locks can be unlocked separately by technical means.

### SUMMARY

(1) The technical problem to be solved

In view of the above-mentioned shortcomings and deficiencies of the prior art, the present disclosure provides an anti-theft lock that solves the problem of anti-theft mechanical combination locks and biometric locks being opened by technical means in the prior art, and also solves the problem of the combination of anti-theft mechanical combination locks and biometric locks still being unlocked by technical means separately.

(2) Technical solution

In order to achieve the above objectives, the main technical solution adopted by the present disclosure is:

An embodiment of the present disclosure provides an anti-theft lock, including:

An anti-theft mechanical combination lock, including an unlocking hook, a lock plate, and a driving wheel, wherein the unlocking hook is provided with a stop lever, the lock plate is provided with a positioning slot, a plurality of the lock plate is provided, and the plurality of the lock plates and the driving wheel are coaxially arranged;

When the unlocking hook is in an effective state, the unlocking hook comes into contact with the driving wheel;

A lock control mechanism, wherein the lock control mechanism is connected to the unlocking hook;

A biometric recognition device, configured to identify biometric information, wherein the biometric recognition device controls the unlocking hook to switch between the effective state and a failed state through the lock control mechanism;

In the case where the biometric information recognized by the biometric recognition device passes a verification, the lock control mechanism releases control of the unlocking hook; if the anti-theft mechanical combination lock is not opened within a preset time, the lock control mechanism resumes control of the unlocking hook to be in a failed state.

Optionally, in the case where the biometric information recognized by the biometric recognition device passes the verification, the number of times that the verification is passed is counted; if the anti-theft mechanical combination lock is not opened and reaches the preset number of times, the recognition function of the biometric recognition device fails within the preset period of time.

If the anti-theft mechanical combination lock is opened, the number of times counted is reset to zero.

Optionally, the anti-theft mechanical combination lock comprises:

A combination dial, wherein the combination dial is coaxially arranged with the driving wheel;

When the lock control mechanism releases control of the unlocking hook, the combination dial drives the driving wheel to rotate, and the driving wheel drives the unlocking hook to pull the lock tongue, such that the anti-theft mechanical combination lock transitions from a locked state to an unlocked state.

Optionally, the anti-theft mechanical combination lock includes:

An electromagnet, wherein the electromagnet is attached to the unlocking hook.

Optionally, the anti-theft mechanical combination lock further includes:

A spring, wherein the spring is connected to the unlocking hook, and is configured to pull the stop lever closer to the lock plate when the lock control mechanism releases control of the unlocking hook.

Optionally, the biometric recognition device includes one or more selected from the group consisting of fingerprint recognition, vein recognition, iris recognition, retina recognition, facial recognition, and DNA recognition.

Optionally, the anti-theft mechanical combination lock further comprises:

A case, wherein the unlocking hook and the lock plate are arranged inside the case;

A code dial, wherein the code dial is fixedly connected to the outer surface of the case, and the combination dial is capable of being rotated relative to the code dial.

(3) Advantageous effects

1. The anti-theft lock mentioned in the present disclosure includes an anti-theft mechanical combination lock, a lock control mechanism, and a biometric recognition device. The biometric recognition device of the anti-theft lock controls whether the anti-theft mechanical combination lock can be opened by the correct code by controlling the lock control mechanism. Its beneficial effect is that only the dual authentication of biological key and mechanical combination code can open the anti-theft lock. On the one hand, it solves the problem of anti-theft mechanical combination lock not recognizing person, even if the combination code leaks, it still cannot be unlocked by others due to the failure of biological key verification; on the other hand, it solves the problem of biometric locks being unlocked by technical means when the biometric key is copied, even if the biometric key is copied, without mastering the mechanical combination code, it cannot be unlocked by others.

2. In the technical solution of the present disclosure, when the unlocking hook of the anti-theft mechanical combination lock fails, the unlocking hook disengages from the driving wheel. Even if all the combination code of the anti-theft mechanical combination lock are correct and aligned, the notch of the driving wheel cannot engage with the hook head of the unlocking hook. When someone attempts to decipher the combination code through continuous trial and error, the correctness of the combination code cannot be verified each time, solving the problem of technical unlocking of anti-theft mechanical combination locks through continuous trial and error to decipher the combination code. At the same time, due to the disengagement between the unlocking hook and the driving wheel, there is no sound of contact between the driving wheel rotation and the unlocking hook, which solves the problem that a thief can decipher the password and open the lock by exploiting the clicking sounds emitted when the hook head of the unlocking hook passes through the contact points at both ends of the notch of the driving wheel.

3. In the technical solution of the present disclosure, when the biometric key verification is passed, the lock control mechanism releases the control of the unlocking hook to make it in an effective state. If the anti-theft mechanical combination lock is not opened within the preset time, the lock control mechanism resumes control of the unlocking hook to reset it to its failed state. The anti-theft lock mentioned in the present disclosure infinitely increases the technical opening time, which is greatly improved compared to the requirement in section 5.3.2.2 of GB37481-2019 General Technical Specification for Vault Doors that “the technical opening resistance time shall be greater than or equal to 20 hours for mechanical combination locks”.

4. The technical solution of the present disclosure counts the number of times the biometric key recognized by the biometric recognition device passes verification. If the anti-theft mechanical combination lock is opened, the number of times counted is reset to zero; if the anti-theft mechanical combination lock is not opened, the unlocking hook will remain in a failed state for a preset period of time when the preset number of times is reached. In this way, biometric key verification and mechanical combination code form mutual verification constraints, achieving the effect of synergistic effect, solving the problem of mechanical combination code and biometric key being decrypted separately by technical means when installing both the anti-theft mechanical combination lock and the biometric lock on the same door.

5. Compared with controlling other unlocking components such as the dial pad, central threaded rod, driving wheel, and wheel group, the unlocking hook of the anti-theft mechanical combination lock controlled by the lock control mechanism in the technical solution of the present disclosure does not have a physical confrontation, which makes it impossible for the transcoding operator to distinguish whether the unlocking failure is due to a code error or the hook being controlled. This not only improves the anti technical opening ability, but also avoids component damage caused by physical confrontation through brute force rotation or violent unlocking.

6. Compared with the solution of using anti-theft mechanical combination locks and biometric locks to jointly control the warehouse or cabinet doors, the integrated fusion of the biometric recognition device and anti-theft mechanical combination lock in the technical solution of the present disclosure has the advantages as following: first, the product volume inside the door cavity is reduced, having a wider range of disclosures, it can not only be applied to large warehouse doors such as bank vaults, but also to various small space use scenarios such as safes; second, it reduces product costs, not only by reducing the cost of a lock controlled by a biometric recognition device, but also by reducing installation workload and implementation costs; third, it can access the internet or local area network (LAN) to realize remote management, control and supervision.

### BRIEF DESCRIPTION OF THE DRAWINGS

FIG. 1 is a schematic structural diagram of an anti-theft lock according to the present disclosure;

FIG. 2 is a schematic structural diagram of an anti-theft mechanical combination lock in the anti-theft lock of the present disclosure;

FIG. 3 is a schematic diagram of the lock control mechanism of the first form of the anti-theft lock mentioned in the present disclosure, showing that the unlocking hook to be in a failed state;

FIG. 4 is a schematic diagram of the lock control mechanism of the first form of the anti-theft lock mentioned in the present disclosure, showing that the unlocking hook to be in an effective state;

FIG. 5 is another schematic diagram of the lock control mechanism of the first form of the anti-theft lock mentioned in the present disclosure, showing that the unlocking hook to be in an effective state;

FIG. 6 is a schematic diagram of the lock control mechanism of the second form of the anti-theft lock mentioned in the present disclosure, showing that the unlocking hook to be in a failed state;

FIG. 7 is a schematic diagram of the lock control mechanism of the second form of the anti-theft lock mentioned in the present disclosure, showing that the unlocking hook to be in an effective state;

FIG. 8 is another schematic diagram of the lock control mechanism of the second form of the anti-theft lock mentioned in the present disclosure, showing that the unlocking hook to be in an effective state;

FIG. 9 is a schematic diagram of the lock control mechanism of the third form of the anti-theft lock mentioned in the present disclosure, showing that the unlocking hook to be in a failed state;

FIG. 10 is a schematic diagram of the lock control mechanism of the third form of the anti-theft lock mentioned in the present disclosure, showing that the unlocking hook to be in an effective state;

FIG. 11 is another schematic diagram of the lock control mechanism of the third form of the anti-theft lock mentioned in the present disclosure, showing that the unlocking hook to be in an effective state;

FIG. 12 is a schematic diagram of the lock control mechanism of the fourth form of the anti-theft lock mentioned in the present disclosure, showing that the unlocking hook to be in a failed state;

FIG. 13 is a schematic diagram of the lock control mechanism of the fourth form of the anti-theft lock mentioned in the present disclosure, showing that the unlocking hook to be in an effective state;

FIG. 14 is another schematic diagram of the lock control mechanism of the fourth form of the anti-theft lock mentioned in the present disclosure, showing that the unlocking hook to be in an effective state;

FIG. 15 is an electronic circuit diagram of one embodiment of a biometric recognition device of the anti-theft lock according to the present disclosure;

FIG. 16 is an unlocking logic diagram of one embodiment of the biometric recognition device of anti-theft lock according to the present disclosure.

Reference numbers labeled in the drawings:

100. anti-theft mechanical combination lock; 110. unlocking hook; 111. stop lever; 112. hook head;

120. lock plate; 121. positioning slot; 130. combination dial; 140. case; 150. code dial; 160. lock tongue; 170. spring; 180. driving wheel; 181. notch; 200. biometric recognition device; 300. lock control mechanism; 311. power-on actuated suction cup electromagnet; 312. energized armature; 321. power-off actuated suction cup electromagnet; 322. de-energized armature; 331. first push-pull electromagnet; 332. first motion armature; 341. second push-pull electromagnet; 342. second motion armature; 343. armature spring.

### DETAILED DESCRIPTION OF THE EMBODIMENTS

In order to illustrate the present disclosure for better understanding, the present disclosure will be described in detail through specific embodiments in conjunction with the accompanying drawings.

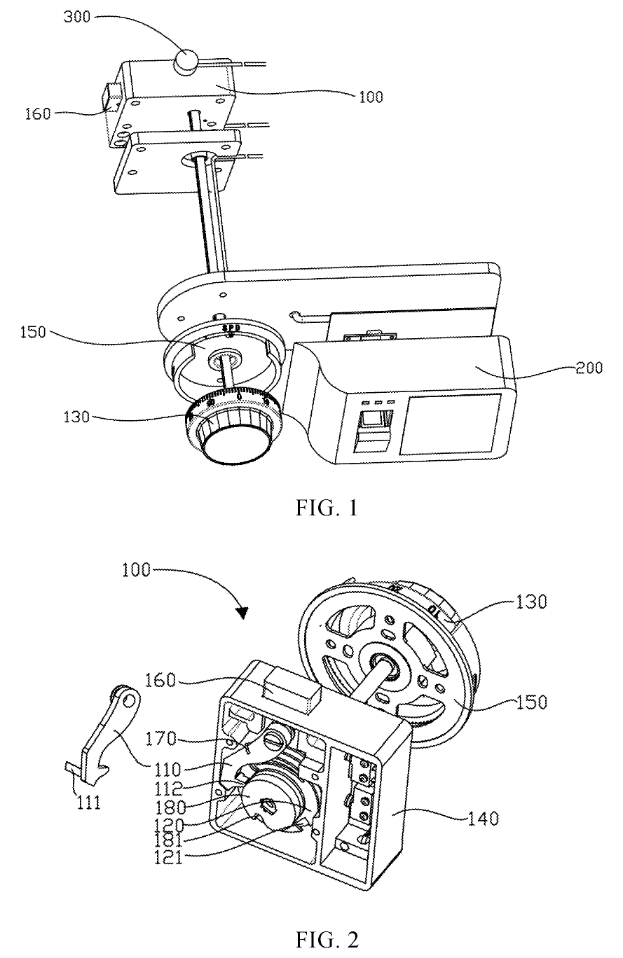

Referring to FIG. 1 and FIG. 2, the anti-theft mechanical combination lock 100 includes: an unlocking hook 110, a lock plate 120, and a driving wheel 180. The unlocking hook 110 is provided with a stop lever 111 and a hook head 112, and the lock plate 120 is provided with a positioning slot 121. A plurality of the lock plate 120 is provided, and the plurality of lock plates 120 and the driving wheel 180 are coaxially arranged. The driving wheel 180 is provided with a notch 181. The stop lever 111 of the unlocking hook 110 is able to enter the positioning slot 121 of the lock plate 120, and the hook head 112 of the unlocking hook 110 is capable of engaging with the notch 181 of the driving wheel 180.

When all the combination code of the anti-theft mechanical combination lock 100 are correctly input, all the positioning slots 121 of the lock plates 120 align in the same straight line, forming a gap. Under the influence of gravity or spring force, the stop lever 111 enters the gap to rotate the driving wheel 180, such that the hook head 112 of the unlocking hook 110 to engage with the notch 181 of the driving wheel 180, thereby driving the unlocking hook 110 to pull the lock tongue 160 to retract to unlock the lock. When the combination code of the anti-theft mechanical combination lock 100 are not correctly input, the positioning slots 121 of the lock plate 120 of the anti-theft mechanical combination lock 100 are arranged in a staggered manner, such that all slots cannot locate on the same straight line, and the stop lever 111 cannot enter through the positioning slots 121, making it impossible for the hook head 112 of the unlocking hook 110 to engage with the notch 181 of the driving wheel 180, and the anti-theft mechanical combination lock 100 cannot be opened.

The anti-theft lock of the present disclosure is provided with a biometric recognition device 200 and a lock control mechanism 300. In the case where the verification of biometric recognition is failed, the lock control mechanism 300 pulls up the unlocking hook 110, so that the hook head 112 of the unlocking hook 110 is separated from the driving wheel 180 and cannot be engaged with the notch 181, thus making the unlocking hook 110 in a failed state.

After the biometric key is verified, the lock control mechanism 300 releases the control of the unlocking hook 110, and the hook head 112 of the unlocking hook 110 contacts with the driving wheel 180, so that the lock can be unlocked with the correct combination code within a preset time. If the anti-theft mechanical combination lock 100 is not successfully opened, the lock control mechanism 300 will restore the control of the unlocking hook 110, so that the unlocking hook 110 is in a failed state again. In this technical solution, for example, after the biometric key is verified, the preset time for releasing the control of the unlocking hook 110 is 3 seconds. Since it usually takes 15-20 seconds to open an anti-theft mechanical combination lock 100 through conventional unlocking process, the actual unlocking must have correctly matched the combination code before biometric verification in order to have time to operate the unlocking. Therefore, under 3 second effective state of the unlocking hook 110, there is not enough trial and error time, avoiding the unlocking hook 110 being unlocked by technical means in the effective state.

The unlocking principle of the anti-theft lock of the present disclosure is as follows: Firstly, the operator rotates the combination dial 130 of the anti-theft mechanical combination lock 100, after all the combination code is matched, and then the biometric key verification is conducted. If the verification is passed, the lock control mechanism 300 releases the control of the unlocking hook 110, and the unlocking hook 110 is in an effective state. If the combination code previously rotated by the operator is completely correct, the stop lever 111 can enter through all positioning slots 121, and then the notch 181 of the driving wheel 180 can be engaged with the hook head 112 of the unlocking hook 110. After then, by rotating the combination dial 130, the driving wheel 180 can drive the unlocking hook 110 to pull the lock tongue 160 to retract, achieving unlocking. If the combination code previously rotated by the operator is not completely correct, the stop lever 111 cannot enter through all the positioning slots 121, so that the notch 181 of the driving wheel 180 can not engage with the hook head 112 of the unlocking hook 110, and the anti-theft mechanical combination lock 100 cannot be opened even if the combination dial 130 is continuously rotated. 3 seconds after the biometric verification is passed, the lock control mechanism 300 resumes control of the unlocking hook 110, returning it to the failed state again.

The present disclosure is different from the traditional technology of double locking by superimposing the anti-theft mechanical combination lock and the biometric recognition lock. By providing a biometric recognition device 200 in the present disclosure, the biometric key of the unlocking person can be verified to determine whether the recognized biometric key has been passed, and to decide whether the lock control mechanism 300 should release control of the unlocking hook 110, so that the unlocking hook 110 can switch between an effective state and a failed state. When a thief wants to crack the traditional anti-theft mechanical combination lock 100, the thief can decipher the combination code by continuously trial and error or by exploiting the clicking sounds emitted when the hook head 112 of the locking hook 110 passes the contact points at both ends of the notch 181 of the driving wheel 181. The anti-theft lock in this disclosure, by pulling up the unlocking hook 110, the hook head 112 of the unlocking hook 110 is out of contact with the driving wheel 180. When someone attempts to decipher the combination code through continuous trial and error, the correctness of each attempt cannot be verified, making it difficult to decipher the combination code through continuous trial and error. At the same time, because the unlocking hook 110 is out of contact with the driving wheel 180, there is no touching sound between the rotation of the driving wheel 180 and the unlocking hook 110, so that thief can not decipher the combination code technically from the ticking sound when the hook head 112 of the unlocking hook 110 passes through the contact points at both ends of the notch 181 of the driving wheel 180. At the same time, even if the thief obtains the combination code of the anti-theft mechanical combination lock 100 through malicious means, it still needs biometric verification, the unlocking hook 110 is in a failed state without biometric verification, making it impossible to unlock.

In this technical solution, if the biometric key recognized by the biometric recognition device 200 passes the verification, the number of times the verification is counted. If the anti-theft mechanical combination lock 100 is opened, the number of times counted is reset to zero; if the anti-theft mechanical combination lock 100 is not opened, the unlocking hook 110 will remain in a failed state for a preset period of time when the preset number of times is reached.

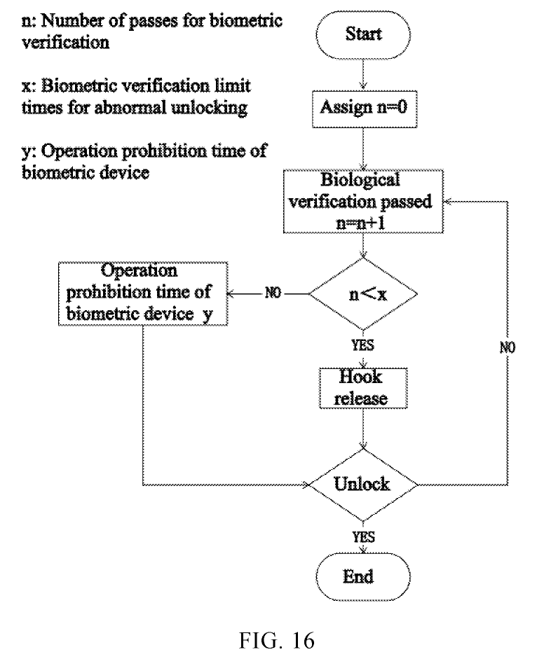

Referring to FIG. 16, n represents the number of times for passing biometric verification, x represents the threshold number of times for passing biometric verification, and y represents the time of the unlocking hook 110 in failed state. When the anti-theft mechanical combination lock 100 is opened, the number of times counted is reset to n=0. Each time the biometric key verification passes, the number of times counted is incremented by 1, that is, n=n+1. When n<x that is, when the number of times for passing biometric verification is less than the threshold number of times for passing biometric verification, the unlocking hook 110 is released, and the number of times counted is reset to zero if the lock is unlocked; when n=x that is, when the number of times for passing biometric verification reaches the threshold number of times for passing biometric verification, the unlocking hook 110 will be in failed state within y time. For example, by using the biometric recognition device 200 to control the unlocking hook 110, the hook head 112 of the unlocking hook 110 cannot engage with the notch 181 of the driving wheel 180. Only after the biometric recognition device 200 is successfully verified, the control of the unlocking hook 110 can be released, and unlocking can be completed with the correct combination code, thereby achieving the effect of controlling the anti-theft mechanical combination lock 100 through the biometric recognition device 200. In the case where the biometric key recognized by the biometric recognition device 200 is successfully verified, the number of times for passing verification is counted. If the anti-theft mechanical combination lock 100 is opened, the number of times counted is reset to zero; if the anti-theft mechanical combination lock 100 is not opened, the unlocking hook 110 will remain in a failed state for a preset period of time when the preset number of times is reached.

It should be noted that the preset time, the preset number of times, and the preset time period mentioned above all need to be pre-set in advance. During the unlocking process, the preset time, the preset number of times, and the preset time period mentioned above are fixed and unchanged.

It can be understood that the present disclosure does not limit a specific value for the preset time, the preset number of times, and the preset time period mentioned above, and any value deemed suitable by the user can be set.

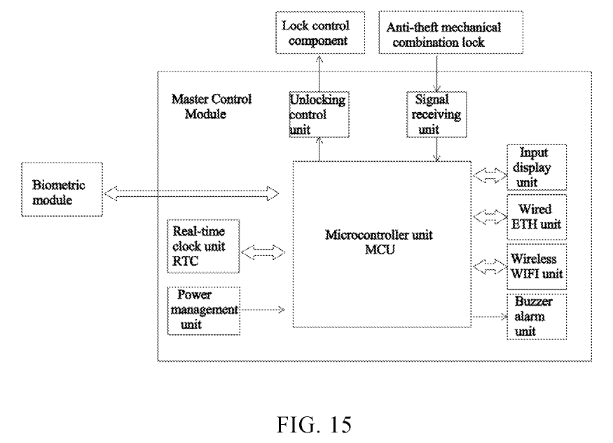

Referring to FIG. 15, FIG. 15 shows the electronic circuit diagram of one embodiment of the biometric recognition device 200 provided in the present disclosure. For example, the biometric recognition device 200 may include a biometric module, an unlocking control unit, a power management unit, a real-time clock unit (RTC clock unit), an input display unit, a wired ETH unit, a wireless WIFI unit, a buzzer alarm unit, etc. The biometric recognition device 200 is integrated with the anti-theft mechanical combination lock 100, and can access the internet or a local area network to achieve remote management, control and supervision.

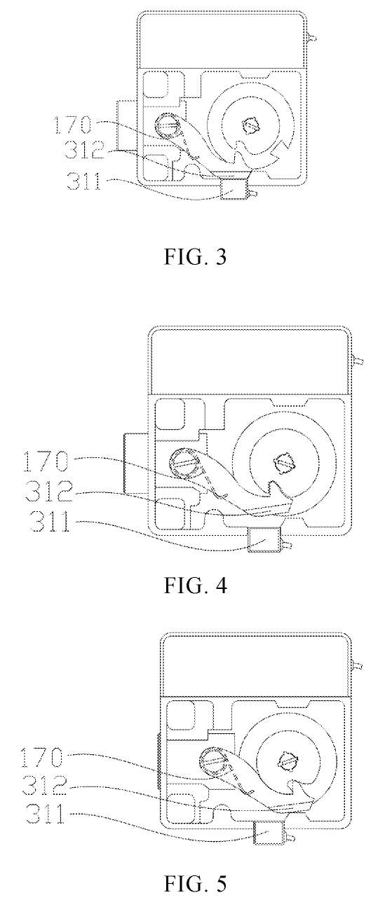

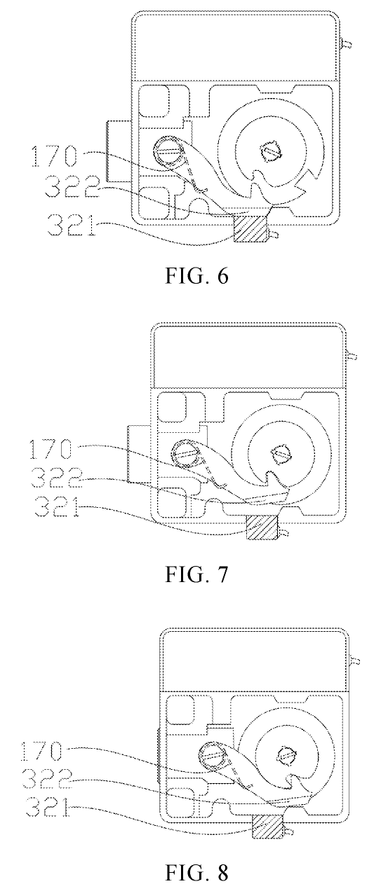

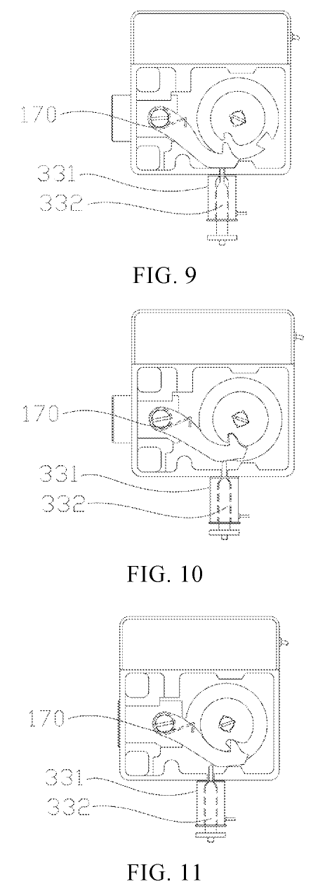

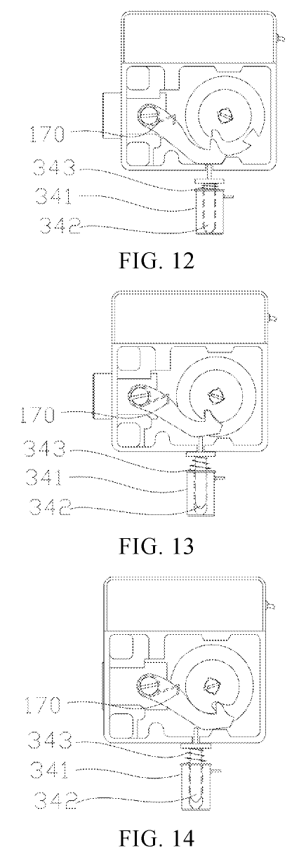

The lock control mechanism 300 includes four forms, among which FIGS. 3-5 are schematic diagrams of the first form, FIGS. 6-8 are schematic diagrams of the second form, FIGS. 9-11 are schematic diagrams of the third form, and FIGS. 12-14 are schematic diagrams of the fourth form. The following will briefly describe them with reference to the accompanying figures.

Referring to FIG. 3, it is a schematic structural diagram of the first form of the lock control mechanism 300 of the anti-theft lock of the present disclosure. In this technical solution, the elastic force of the spring 170 is in the same direction as the hook head 112. The lock control mechanism 300 includes a power-on actuated suction cup electromagnet 311 and an energized armature 312. The energized armature 312 is installed on the unlocking hook 110, and the energized armature 312 is installed opposite the hook head 112. The power-on actuated suction cup electromagnet 311 is installed at the corresponding position of the energized armature 312. Referring to FIG. 4 and FIG. 5, when the power is cut off, the power-on actuated suction cup electromagnet 311 loses its magnetic force, the energized armature 312 is released, and the unlocking hook 110 is in an effective state under the elastic force of the spring 170; when the power-on actuated suction cup electromagnet 311 is powered on, a magnetic force is generated, which overcomes the elastic force of the spring 170 and the energized armature 312 is attracted by the magnetic force, thereby causing the unlocking hook 110 to be in a failed state.

Referring to FIG. 6, it is a schematic structural diagram of the second form of the lock control mechanism 300 of the anti-theft lock of the present disclosure. In this technical solution, the elastic force of the spring 170 is in the same direction as the hook head 112. The lock control mechanism 300 includes a power-off actuated suction cup electromagnet 321 and a de-energized armature 322. The de-energized armature 322 is installed on the unlocking hook 110, and the de-energized armature 322 is installed opposite the hook head 112. The power-off actuated suction cup electromagnet 321 is installed at the corresponding position of the de-energized armature 322. Referring to FIG. 7 and FIG. 8, when the power-off actuated suction cup electromagnet 321 is powered on, it loses its magnetic force, and the de-energized armature 322 is released, under the elastic force of the spring 170, the unlocking hook 110 is in an effective state; when the power-off actuated suction cup electromagnet 321 is powered off, a magnetic force is generated, which overcomes the elastic force of the spring 170 and causes the de-energized armature 322 to be attracted by the magnetic force, thereby rendering the unlocking hook 110 in a failed state.

Referring to FIG. 9, it is a schematic structural diagram of the third form of the lock control mechanism 300 of the anti-theft lock of the present disclosure. In this technical solution, the elastic force of the spring 170 is opposite to that of the hook head 112. The lock control mechanism 300 includes a first push-pull electromagnet 331 and a first motion armature 332. Referring to FIG. 10 and FIG. 11, when the first push-pull electromagnet 331 is powered on, one end of the first motion armature 332 contacts the unlocking hook 110 to overcome the elastic force of the spring 170, so that the unlocking hook 110 is in an effective state; when the first push-pull electromagnet 331 is powered off, the first motion armature 332 loses its magnetic force, and the unlocking hook 110 is in a failed state under the elastic force of the spring 170.

Referring to FIG. 12, it is a schematic structural diagram of the fourth form of the lock control mechanism 300 of the anti-theft lock of the present disclosure. In this technical solution, the elastic force of the spring 170 is opposite to that of the hook 112. The lock control mechanism 300 includes a second push-pull electromagnet 341, a second motion armature 342, and an armature spring 343. Referring to FIG. 13 and FIG. 14, when the second push-pull electromagnet 341 is powered off, the second motion armature 342 overcomes the elastic force of the spring 170 under the action of the armature spring 343, so that the unlocking hook 110 is in an effective state; when the second push-pull electromagnet 341 is powered on, the magnetic force of the second motion armature 342 overcomes the elastic force of the armature spring 343, causing the unlocking hook 110 to be in a failed state.

To fully illustrate the security of the anti-theft lock of the present disclosure, the following example simulates a thief's attempt to crack the code through a trial-and-error process:

The thief first rotates the anti-theft mechanical combination lock 100 to match a set of combination code, and then performs biometric verification. Even if the biometric verification is passed, if the mechanical combination code is incorrect, the lock cannot be opened. Of course, if the biometric verification is not passed, the lock cannot be opened, and the thief does not know whether the mechanical combination code is correct at this time. Therefore, the mechanical combination code cannot be deciphered by trial and error. In addition, if the biometric verification is passed multiple times but cannot be unlocked, the unlocking function is prohibited for a period of time. In this way, the anti-theft lock of the present disclosure infinitely increases the technical opening time, compared to the requirement in section 5.3.2.2 of GB37481-2019 General Technical Specification for Vault Doors that “the technical opening resistance time shall be greater than or equal to 20 hours for mechanical combination locks”, it is greatly improved.

In this technical solution, the biometric recognition device 200 includes any one or more recognition methods such as fingerprint recognition, vein recognition, iris recognition, retina recognition, facial recognition, and DNA recognition. At least one of the multiple biometric methods can be selected, and they can be combined when there are two or more biometric methods are selected, thereby further improving the security of the anti-theft mechanical combination lock 100.

In this technical solution, the anti-theft mechanical combination lock 100 further includes:

A case 140, wherein the unlocking hook 110 and the lock plate 120 are arranged inside the case 140;

A code dial 150, which is fixedly connected to the outer surface of the case 140, and the combination dial 130 is capable of being rotated relative to the code dial 150.

It should be noted that the case 140 is provided, in which the unlocking hook 110 and the lock plate 120 are set inside the case 140. The case 140 shields the internal structure of the anti-theft mechanical combination lock 100, namely the connection relationship between the lock plate 120 and the unlocking hook 110, the transmission relationship between multiple lock plates 120, and the position relationship of the positioning slots 121 on multiple lock plates 120, so that the operator cannot know the transmission relationship of the anti-theft mechanical combination lock 100, thereby improving the security of the anti-theft mechanical combination lock 100.

It should be noted that the code dial 150 is fixedly connected to the outer surface of the case 140, and the combination dial 130 is capable of being rotated relative to the code dial 150. For example, the code dial 150 is marked with a standard scale line corresponding to the lock plate 120. The rotation of the combination dial 130 relative to the scale line of the code dial 150 can effectively control the lock plate 120 and improve operational convenience.

The integrated fusion of the biometric recognition device 200 and the anti-theft mechanical combination lock 100 in the technical solution of the present disclosure has the advantages of reducing the product volume inside the door cavity and making it more widely applicable. It can not only be applied to large warehouse doors such as bank vaults, but also to various use cases with limited space such as safes, compared to the solution of using the anti-theft mechanical combination lock 100 and the biometric lock to jointly control warehouse doors or cabinet doors; secondly, it reduces product costs, not only by reducing the cost of a lock controlled by a biometric recognition device 200, but also by reducing installation workload and implementation costs; third, it can access the Internet or LAN to realize remote management, control and supervision.

In the description of the present disclosure, it should be understood that the terms "first" and "second" are only used for descriptive purposes and cannot be understood as indicating or implying relative importance or implying the number of technical features indicated. Thus, the features limited to "first" and "second" may explicitly or implicitly include one or more of these features. In the description of the present disclosure, "multiple" means two or more, unless otherwise specifically limited.

In the present disclosure, unless otherwise specified and limited, the terms "install", "connected with", "connected to", "fix", etc. should be broadly understood, for example, they can be fixed connections, detachable connections, or integrated into one; it can be a mechanical connection or an electrical connection; it can be directly connected or indirectly connected through an intermediate medium; it can be a connection within two components or an interaction relationship between two components. For ordinary skilled person in the art, the specific meanings of the above terms in the present disclosure can be understood according to the specific situation.

In the present disclosure, unless otherwise specified and limited, the first feature is located "above" or "below" the second feature, which may be direct contact between the first and second features, or indirect contact between the first and second features through an intermediate medium. Moreover, if the first feature is "above", "over", or "upon" the second feature, it can be directly above or diagonally above the second feature, or simply indicate that the first feature is horizontally higher than the second feature. The first feature is "below", "under", and "beneath" the second feature, which can be directly or diagonally below the second feature, or simply indicate that the first feature is horizontally lower than the second feature.

In the description of this specification, the terms "one embodiment", "some embodiments", "embodiments", "examples", "specific examples" or "some examples" refer to the specific features, structures, materials or characteristics described in conjunction with the embodiments or examples included in at least one embodiment or example of the present disclosure. In above description, the schematic expressions of the above terms do not necessarily refer to the same embodiments or examples. Moreover, the specific features, structures, materials, or characteristics described can be combined in any one or more embodiments or examples in an appropriate manner. In addition, under the condition without conflicting with each other, the skilled person in the art can combine the different embodiments or examples described in this specification, as well as the features of different embodiments or examples.

Although the embodiments of the present disclosure have been shown and described above, it can be understood that the above embodiments are exemplary and should not be construed as limitations to the present disclosure. Those of ordinary skill in the art may make changes, modifications, substitutions, and variations to the above embodiments within the scope of the present disclosure.

What is claimed is:

1. An anti-theft lock, comprising:
an anti-theft mechanical combination lock, comprising an unlocking hook, a lock plate, and a driving wheel, wherein the unlocking hook is provided with a stop lever and a hook head, the lock plate is provided with a positioning slot, a plurality of the lock plate is provided, and the plurality of the lock plates and the driving wheel are coaxially arranged;
the driving wheel is provided with a notch, the stop lever of the unlocking hook enters the positioning slot of the lock plate, and the hook head of the unlocking hook is engaged with the notch of the driving wheel;
the anti-theft mechanical combination lock further comprises a lock tongue, one end of the unlocking hook is connected to the stop lever, and the other end is connected to the lock tongue;
when the unlocking hook is in an effective state, the unlocking hook comes into contact with the driving wheel;
a lock control mechanism, wherein the lock control mechanism is connected to the unlocking hook;
a biometric recognition device, configured to identify biometric information, wherein the biometric recognition device controls the unlocking hook to switch between the effective state and a failed state through the lock control mechanism;
in the case where the biometric information recognized by the biometric recognition device passes a verification, the lock control mechanism releases control of the unlocking hook; if the anti-theft mechanical combination lock is not opened within a preset time, the lock control mechanism resumes control of the unlocking hook to be in a failed state.

2. The anti-theft lock according to claim 1 wherein:
in the case where the biometric information recognized by the biometric recognition device passes the verification, the number of times that the verification is passed is counted; if the anti-theft mechanical combination lock is not opened and reaches the preset number of times, a recognition function of the biometric recognition device fails within the preset period of time;
if the anti-theft mechanical combination lock is opened, the number of times counted is reset to zero.

3. The anti-theft lock according to claim 1 further comprising:
a combination dial, wherein the combination dial is coaxially arranged with the driving wheel;
when the lock control mechanism releases control of the unlocking hook, the combination dial drives the driving wheel to rotate, and the driving wheel drives the unlocking hook to pull the lock tongue, such that the anti-theft mechanical combination lock transitions from a locked state to an unlocked state.

4. The anti-theft lock according to claim 2 wherein the lock control mechanism comprises:
an electromagnet, wherein the electromagnet is attached to the unlocking hook.

5. The anti-theft lock according to claim 1 wherein the anti-theft mechanical combination lock further comprises:
a spring, wherein the spring is connected to the unlocking hook, and is configured to pull the stop lever closer to the lock plate when the lock control mechanism releases control of the unlocking hook.

6. The anti-theft lock according to claim 1 wherein:
the biometric recognition device comprises one or more selected from the group consisting of fingerprint recognition, vein recognition, iris recognition, retina recognition, facial recognition, and DNA recognition.

7. The anti-theft lock according to claim 3 wherein the anti-theft mechanical combination lock further comprises:
a case, wherein the unlocking hook and the lock plate are arranged inside the case;
a code dial, wherein the code dial is fixedly connected to an outer surface of the case, and the combination dial is capable of being rotated relative to the code dial.
